(19) United States
(12) Patent Application Publication
(10) Pub. No.: US 2004/0179451 A1
(43) Pub. Date: Sep. 16, 2004

(54) Square-wave signal modifying device, light emission control device and current supply device suitable for use in high-speed writing on recording medium

(76) Inventors: Morito Morishima, Hamamatsu (JP); Kazuhiko Honda, Hamamatsu (JP); Masao Noro, Hamamatsu (JP); Nobuaki Tsuji, Hamamatsu (JP)

Correspondence Address: PILLSBURY MADISON & SUTRO LLP, Suite 1200, 725 South Figueroa, Los Angeles, CA, 90017-5443, US

(21) Appl. No.: 09/772,786

(22) Filed: Jan. 30, 2001

(30) Foreign Application Priority Data
Feb. 1, 2000 (JP) NO.2000-28908

(51) Int. Cl. G11B 7/0045

(52) U.S. Cl. 369/59.11

(57) ABSTRACT

Optical disk writing apparatus includes a flexible substrate connecting a main sheep and a pickup section. Because the flexible substrate has poor frequency characteristics, a frequency band for signals transmitted through the flexible substrate is lowered. Namely, a write strategy circuit and the like which output signals containing a lot of high-frequency components are provided in the pickup section. Further, to suppress an amount of heat emission from the pickup section, the main sheet section includes a constant-current supply/current consumption circuit that consumes a current not consumed by a laser diode.

### BACKGROUND OF THE INVENTION

The present invention relates to an improved square-wave-signal modifying device, light emission control device and current supply device that are suitable for use in apparatus for writing desired information on an optical disk or other recording medium.

Generally, optical disk writing apparatus include an optical pickup section provided in opposed, proximate relation to an optical disk, and a main sheet section on which is provided a control device for performing various control on the optical pickup section. Because the optical pickup section moves in accordance with an instructed data writing or recording operation, the main sheet section and the optical pickup section are connected with each other via a flexible substrate functioning as a flexible signal transmission path section. The flexible substrate comprises, for example, a plurality of flat conducting lines sandwiched between two films and has a great distributed capacitance per length. Further, because the optical pickup section must receive each control signal from the main sheet section without fail, the main sheet section and optical pickup section are provided with a reliable driver circuit and receiver circuit, respectively.

In most cases, the optical disk writing apparatus use a laser diode for writing desired information onto an optical disk. Also, the optical disk writing apparatus include a plurality of photodiodes, which receive laser light reflected off the optical disk so as to read out recorded information from the optical disk. The reflected laser light received via the plurality of photodiodes is also used for monitoring conditions of the information writing on the optical disk and performing servo control on the optical pickup section on the basis of the monitored writing conditions. Note that in this specification, these photodiodes will hereinafter be referred to as “reproducing photodiodes” or “first light receiving elements”. The optical disk writing apparatus includes, apart from the reproducing photodiodes, another photodiode that will hereinafter be referred to as a “front monitor diode” or second light receiving element.

<Laser Power Control>

To keep appropriate the amount of light emission from the laser diode in the optical disk writing apparatus, an electric current for driving the laser diode (laser-diode driving current) is controlled in accordance with an amount of light received by the front monitor diode or reproducing photodiodes (i.e., output current from the front monitor diode or reproducing photodiodes). Three different types of control have been used for controlling the laser-diode driving current, as will be briefed below.

(1) APC:

According to this control technique, the output current from the front monitor diode is compared with a target current value so that the laser-diode driving current is increased or decreased on the basis of a difference between the two.

(2) OPC:

The above-mentioned APC technique requires the “target value” to be set in advance. In an optical disk, such as a CD-R disk, there is previously provided an OPC test area. Before actual writing onto the optical disk, the OPC technique writes information onto the previously-provided OPC test area while varying the laser-diode driving current in the neighborhood of a predetermined write level in a stepwise, wave-like fashion. Then, the OPC technique reads the OPC test area to identify an optimum output current of the photodiodes, and determines the target value on the basis of the thus-identified output current.

(3) ROPC:

Although the above-mentioned OPC technique is executed at the time of insertion of the optical disk into the writing apparatus, the light emitting characteristics of the laser diode would fluctuate after initiation of the writing due to changes in ambient temperature etc. Thus, this ROPC technique successively detects the output current from the reproducing photodiodes at pit-forming timing even in the course of the writing operation, and then modifies the target value on the basis of the detected results.

<Write Strategy Process>

As well known in the art, each signal to be written onto a CD-R or other optical disk is called an EFM signal, where there alternately occurs a time period of a logical value “1” (i.e. pit-forming time period) and a time period of a logical value “0” (i.e., non-pit-forming or blank-forming time period) each having a length in a range of 3T-11T based on a predetermined unit period T. The EFM signal is originally in the form of a complete square wave, but if such a square wave is directly used for later power control, there would arise various inconveniences; for example, pits formed in the optical disk would deviate from predetermined pit lengths or would be distorted due to variations in the recording speed, heat accumulation condition, etc.

Thus, any of various waveform modification processes is usually performed on the square wave of the EFM signal, and such a waveform modification process is commonly called a write strategy process. In FIGS. 3A to 3F, there is shown a specific example of the conventional write strategy process that is applied to a CD-R disk. FIG. 3A denotes a recording EFM signal, in synchronism with which is generated a write-level pulse (denoted in FIG. 3C), start-level pulse (denoted in FIG. 3D) or read-level pulse (denoted in FIG. 3E).

By appropriately superposing constant currents IIW, IIE and IIR with their respective levels switched in response to the write-level pulse, start-level pulse or read-level pulse, there can be obtained a recording waveform, i.e. laser-diode driving current, as denoted in FIG. 3B. More specifically, the recording waveform, i.e. laser-diode driving current, is set to a high level, immediately after its rise, in response to a rise of the start-level pulse. Namely, since there is no heat accumulation immediately after the rise, the recording waveform is set to a level high enough to prevent a recorded pit from being deformed into a teardrop-like shape. Further, because the effect of the heat accumulation tends to vary with the recording speed, timing immediately after the rise of the recording waveform would correspond to timing near the rise of the recording EFM signal.

Further, the recording waveform is set, immediately after its fall, to a value lower than the read level. This is to rapidly cool the heat so far accumulated, to thereby prevent the trailing end of a recorded pit from extending or deviating rearward beyond a predetermined location. In this case too, because the effect of the heat accumulation tends to vary with the recording speed, timing immediately after the fall of the recording waveform would correspond to timing near (i.e., immediately before or after) the fall of the recording EFM signal. Note that “IIB” denoted in FIG. 3B represents a base-level current that is constantly added to the recording waveform when the writing apparatus is in a write-enabled sate.

Although there has been a great demand for optical disk writing apparatus capable of operating at higher speed, the conventional apparatus would present limitations to an increase in the operating speed; such operating speed limitations would become more serious with DVD-R disks than with CD-R disks. This is because the increased operating speed would lead to various problems as discussed below.

First, as the operating speed of the optical disk writing apparatus is increased, frequency components of the recording waveform tend to become higher. If a signal transmission path section implemented by the flexible substrate is increased in length, the distributed capacitance would degrade frequency characteristics and thus the frequency components would attenuate to the extent that the recording waveform can be not used any longer. Further, as the writing speed is increased, the laser-diode driving current would be controlled to be greater. Depending on the type of laser diode used, the laser-diode driving current could amount to 300 mA or higher, in response to which the optical pickup section would emit great heat. If such a high current is transferred via the flexible substrate, the frequency of the current may be increasing to such a level that unnecessary irradiation from the flexible substrate becomes a serious problem.

Also known in the art is the so-called “additional writing” which resumes writing information onto an optical disk, having a track formed halfway, at a point following the halfway point of the track. To perform the “additional writing”, the laser diode is turned on with the read-level power to trace the track, and then raised to the write-level power level upon detection of an end of the already-written region of the track.

However, it normally takes a certain amount of time for the write-level power to stabilize at a predetermined value. If the writing speed doubles, the necessary number of rotations of the optical disk also doubles, so that a total length of the track to be traced by the optical pickup section until the write-level power stabilizes also doubles. This doubling of the necessary traced length tends to invite writing errors that are very likely to produce errors at the time of readout of recorded information. To avoid such inconveniences, there is a need to reduce, approximately by half, the time required for the write-level power to stabilize.

Further, the above-mentioned driver circuit and receiver circuit, provided in the transmitting and receiving ends of the control signal, would become jitter-increasing factors and hence non-stable elements when the apparatus is operating at increased speed.

### SUMMARY OF THE INVENTION

It is therefore an object of the present invention to provide a square-wave-signal modifying device, light emission control device and current supply device which allow an optical disk writing apparatus to appropriately operate at increased speed.

In order to accomplish the above-mentioned object, the present invention provides a square-wave modifying device for use in a recording apparatus of a type which includes a pickup section provided in proximity to a recording medium, a flexible signal transmission path section connected to the pickup section and having a character of attenuating a high-frequency component of a signal to be transmitted therethrough and a main sheet section connected to the pickup section via the signal transmission path section, and the square-wave modifying device of the present invention comprises: a square-wave signal transmission section, provided in the main sheet section, for supplying a first square-wave signal to one end of the signal transmission path section; and a waveform modification section, provided in the pickup section, for receiving a second square-wave signal from another end of the signal transmission path section, the waveform modification section modifying a waveform of the second square-wave signal so that a level of the waveform is raised for a predetermined first time period at timing near a rise of the second square-wave signal and the level of the waveform is lowered for a predetermined second time period at timing near a fall of the second square-wave signal.

According to another aspect of the present invention, there is provided a square-wave modifying device for use in a recording apparatus comprising a pickup section provided in proximity to a recording medium, a flexible signal transmission path section connected to said pickup section and having a character of attenuating a high-frequency component of a signal to be transmitted therethrough and a main sheet section connected to said pickup section via said signal transmission path section, said square-wave modifying device comprising a square-wave signal transmission section, provided in said main sheet section, for supplying a first square-wave signal to one end of said signal transmission path section, and a waveform modification section, provided in said pickup section, for receiving a second square-wave signal from another end of said signal transmission path section of said second square-wave wave signal so that the waveform is raised at timing near a rise of said second square-wave signal and upper level of the waveform is raised for a predetermined first time period, and the waveform is lowered at timing near a fall of said second square-wave signal and an under level of the waveform is lowered for a predetermined second time period.

According to another aspect of the invention, there is provided a square-wave modifying device for use in a recording apparatus comprising a pickup section provided in proximity to a recording medium, a flexible signal transmission path section connected to said pickup section and having a character of attenuating a high-frequency component of a signal to be transmitted therethrough and a main sheet section connected to said pickup section via said signal transmission path section, said square-wave modifying device comprising a square-wave signal transmission section, provided in said main sheet section, for supplying a first square-wave signal to one end of said signal transmission path section, and a waveform modification section, provided in said pickup section, for receiving a second square-wave signal from another end of said signal transmission path section of said second square-wave signal so that the waveform is raised at timing near a rise of said second square-wave signal and an upper level of the waveform is raised for a predetermined first time period, and the waveform is lowered at timing near a fall of a write-level pulse and an under level of the waveform is lowered for a predetermined second time period.

According to another aspect of the present invention, there is provided a light emission control device for use in a recording apparatus of a type which includes a pickup section provided in proximity to a recording medium, a flexible signal transmission path section connected to the pickup section and having a character of attenuating a high-frequency component of a signal to be transmitted therethrough and a main sheet section connected to the pickup section via the signal transmission path section, and the light emission control device of the present invention comprises: a light-emitting element provided in the pickup section; a first light-receiving element provided in the pickup section; a second light-receiving element provided in the pickup section; a storage section, provided in the pickup section, for storing a target value of an amount of light reception by the second light-receiving element; a control, provided in the pickup section, for, in a first operation mode (recording mode), adjusting an amount of light emission by the light-emitting element so that the amount of light received by the second light-receiving element approaches the target value, and for, in a second operation mode (OPC mode), writing, into the storage section, another target value obtained on the basis of an amount of light received by the first light-receiving element; and an operation mode setting section, provided in the main sheet section, for indicating an operation mode to be selected to the control via the signal transmission path section.

In the light emission control device of the present invention, the control receives, as a digital signal, the amount of light received by the second light-receiving element and supplies, as a digital signal, the amount of light emission by the light-emitting element. For this purpose, the light emission control device may further comprise: an A/D converter for converting an output current value of the second light-receiving element into a digital signal and supplies the converted digital signal to the control; and a D/A converter for, on the basis of the amount of light emission represented by the digital signal supplied by the control, outputting a signal proportional to a value of a current to be supplied to the light-emitting element.

The present invention also provides a light emission control device for use in a recording apparatus of a type which includes a pickup section provided in proximity to a recording medium, a flexible signal transmission path section connected to the pickup section and having a character of attenuating a high-frequency component of a signal to be transmitted therethrough and a main sheet section connected to via the signal transmission path section to the pickup section, and the light emission control device of the present invention comprises: a light-emitting element provided in the pickup section; a first light-receiving element provided in the pickup section; a second light-receiving element provided in the pickup section; a received-light-amount transmission section, provided in the pickup section, for converting the amount of light received by the second light-receiving element into a first serial signal and transmitting the first serial signal to the main sheet section via the signal transmission path section; a control information generation section, provided in the main sheet section, for generating control information for controlling an amount of light emission by the light-emitting element on the basis of the amount of light received having been supplied via the signal transmission path section; and a control information transmission section, provided in the main sheet section, for converting the control information into a second serial signal and transmitting the second serial signal to the pickup section via the signal transmission path section.

According to still another aspect of the present invention, there is provided a control device which comprises: a first feedback loop for detecting an amount of light emission by a light-emitting element (e.g., output current of a front monitor diode) and outputting a first operation amount (e.g., gate voltage of an FET) for controlling a predetermined object of control in accordance with a difference between the detected amount of light emission and a target light emission value; and a second feedback loop for outputting a second operation amount (e.g., values of constant currents to a current D/A converter) for controlling the predetermined object of control in accordance with a difference between the detected amount of light emission and the target light emission value, the second feedback loop having a lower response speed than the first feedback loop. Thus, the amount of light emission by the light-emitting element is controlled to approach the target light emission value.

In the control device of the present invention, the first feedback loop may include a differential amplifier that receives the amount of light emission and the target light emission value as analog signals and outputs the first operation amount as an analog value. The second feedback loop may include: an A/D converter for converting the amount of light emission into a digital value; a memory for storing the target light emission value as a digital value; a control that outputs the second operation amount as a digital value on the basis of the digital values representing the amount of light emission and the target light emission value; and a D/A converter for converting the second operation amount into an analog value.

According to still another aspect of the present invention, there is provided a current supply device for use in a recording apparatus of a type which includes a pickup section provided in proximity to a recording medium, a flexible signal transmission path section connected to the pickup section and having a character of attenuating a high-frequency component of a current to be transmitted therethrough and a main sheet section connected via the signal transmission path section to the pickup section. Here, the current supply device, which supplies, via a switch section, a current from the main sheet section to a light-emitting element load within the pickup section, comprises: first and second signal lines provided in the signal transmission path section and each having a character of attenuating a high-frequency component of a current to be transmitted therethrough; a current supply, provided in the main sheet section, for supplying a constant current to the pickup section via the first signal line; a dummy load provided in the main sheet section; the switch section, provided in the pickup section, for feeding the current, supplied via said first signal line, to the light-emitting element or to the dummy load via the second signal line while switching between the light-emitting element and the dummy load in a complementary fashion.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing a general setup of an optical disk writing apparatus in accordance with a first embodiment of the present invention;

FIG. 2 is a block diagram showing a general setup of an optical disk writing apparatus in accordance with a second embodiment of the present invention;

FIGS. 3A to 3F are waveform diagrams explanatory of a write strategy process performed in a conventionally-known optical disk writing apparatus and in the first and second embodiments of the present invention; and

FIG. 4 is a block diagram showing details of a laser driver etc. employed in the first and second embodiments of the present invention.

### DETAILED DESCRIPTION OF THE PREFERRED EMBODIMENTS

1. First Embodiment:

1.1. Organization of First Embodiment:

1.1.1. General Organization of First Embodiment:

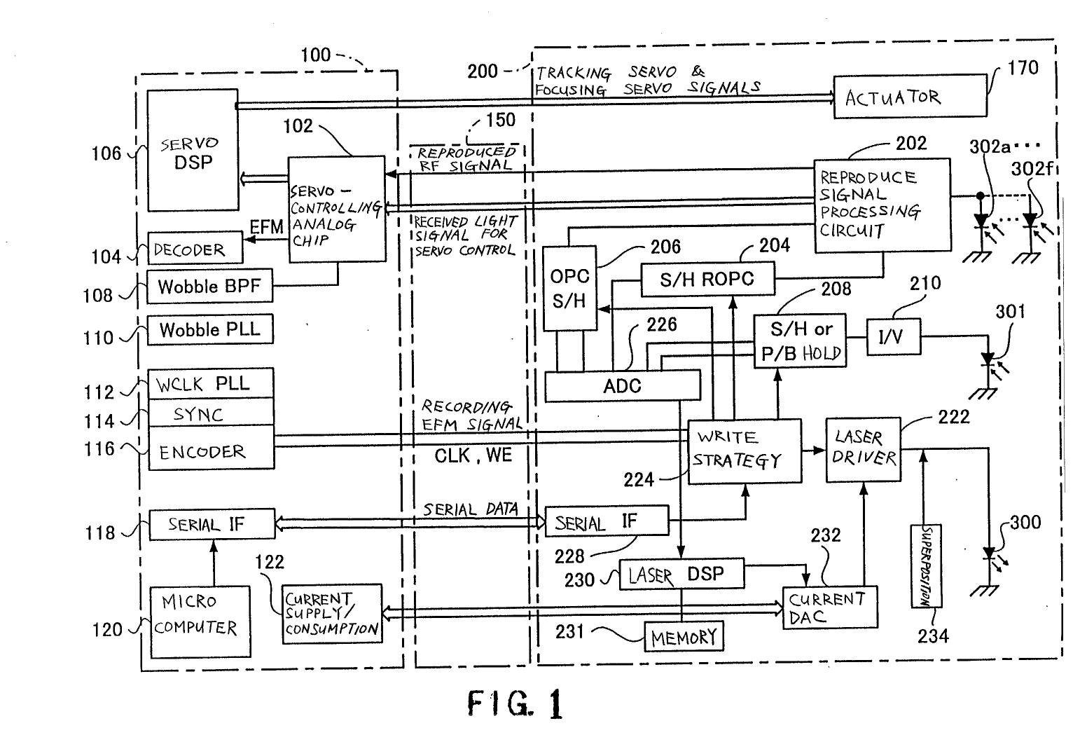

FIG. 1 is a block diagram showing a general setup of an optical disk writing apparatus in accordance with a first embodiment of the present invention. As shown, the optical disk writing apparatus includes a main sheet section 100, a pickup section 200, and a flexible substrate 150 connecting the main sheet section 100 and pickup section 200 as a flexible signal transmission path section between the main sheet section 100 and pickup section 200. Within the pickup section 200, there is provided a reproduced light processing circuit 202 which generates a reproduced RF signal on the basis of output currents from a total of six reproducing photodiodes 302a to 302f, i.e., four reproducing photodiodes that together constitute a four-quadrant or four-part light receiving section and two reproducing photodiodes that constitute two other light receiving sections disposed above and below the four-quadrant light receiving section. The reproduced light processing circuit 202 also supplies, via the flexible substrate or signal transmission path section 150, the respective output current values A to F from the reproducing photodiodes 302a to 302f to a servo-controlling analog chip 102 of the main sheet section 100. The servo-controlling analog chip 102 shapes a wave of the reproduced RF signal to provide it as a reproduced EFM signal, and also generates various control signals, such as a tracking error signal, focusing error signal and wobble signal, using the output signals from the reproducing photodiodes 302a to 302f.

The main sheet section 100 includes a decoder 104 that decodes the reproduced EFM signal and outputs the decoded result to the outside as parallel digital signals. The main sheet section 100 also includes a servo DSP (Digital Signal Processor) 106 that generates a tracking servo signal and focusing servo signal on the basis of the tracking error signal, focusing error signal and wobble signal generated by the servo-controlling analog chip 102. The tracking servo signal and focusing servo signal are supplied from the servo DSP 106 to an actuator 170, which controls the position of the pickup section 200 in accordance with the tracking servo signal and focusing servo signal.

Further, in the main sheet section 100, a wobble BPF (Band-Pass Filter) 108 extracts a necessary wobble component from the wobble signal generated by the servo-controlling analog chip 102. Reference numeral 110 represents a wobble PLL (Phase-Locked Loop) that stabilizes the extracted wobble component. Reference numeral 112 represents a write clock PLL (Phase-Locked Loop), which, on the basis of an output signal from the wobble PLL 110, generates basic clock pulses WCLK (having a period T) for generation of a recording EFM signal.

The main sheet section 100 also includes an encoder 116 that, on the basis of parallel digital signals input from the outside, generates a recording EFM signal in synchronism with the basic clock pulses WCLK. Reference numeral 114 represents a synchronization circuit 114 that outputs a write enable signal when the recording EFM signal is to be output. The main sheet section 100 further includes a microcomputer 120 that comprises a ROM having stored therein programs, a RAM for use as a working area, and a CPU for controlling various components of the main sheet section 100 on the basis of the programs stored in the ROM.

Further, in the main sheet section 100, a serial interface 118 communicates, via the flexible substrate 150, various control signals with a serial interface 228 of the pickup section 200. Namely, each of the serial interfaces 118 and 228 transmits information to the other party after converting the information into a serial signal in the form of a balanced differential current signal.

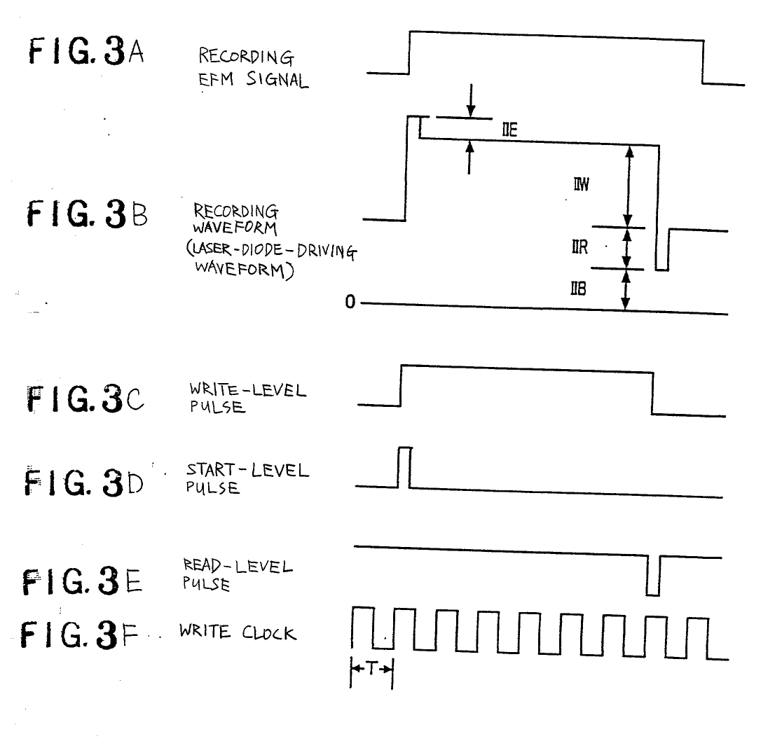

The main sheet section 100 also includes a current supply/consumption circuit 122 that supplies the pickup section 200 with a constant current. The constant current has a value corresponding to a combination of a peak or maximum value of the laser-diode driving current (IIW+IIE+IIR+IIB in the illustrated example of FIG. 3) and a slight margin. A dummy load is provided for the current supply/consumption circuit 122, and this dummy load consumes an electric current returning from the pickup section 200.

The pickup section 200 includes a write strategy circuit 224, which, on the basis of a received waveform of the recording EFM signal, generates control pulses (see FIG. 3) to be used for performing any of various waveform modifications such that a laser diode 300 generates a laser-diode driving signal suitable for actually recording the recording EFM signal onto an optical disk. To perform the APC, OPC and ROPC control on the laser diode 300, it is necessary to sample output currents of the reproducing photodiodes 302a to 30f or front monitor diode 301 at appropriate timing. Thus, the write strategy circuit 224 also generates sampling clock pulses to be used for sampling the output currents of the reproducing photodiodes 302a to 302f or front monitor diode 301.

While the write strategy circuit in the conventionally-known optical disk writing apparatus was provided in the main sheet section, the write strategy circuit 224 in the instant embodiment is provided in the pickup section 200. The reason why the write strategy circuit 224 is provided in the pickup section 200 in the instant embodiment is that high-frequency components of the recording waveform increase with an increase in the writing speed relative to the optical disk and transmitting such a recording waveform via the flexible substrate 150 will result in degradation of the recording signal.

Thus, in the instant embodiment, a laser driver 222 can be positioned immediately following the write strategy circuit 224, so that burdens on the write strategy circuit 224 can be significantly reduced and degradation of the high-frequency components can also be effectively prevented. As a consequence, rise and fall times of the recording EFM signal can be kept substantially constant, and variations in a duty factor of the recording EFM signal can also be suppressed. Further, the instant embodiment thus arranged can minimize the number of extra intervening circuits and also minimize undesired jitters. Note that although the recording EFM signal and basic clock pulses WCLK are transferred via the flexible substrate or signal transmission section 150 in the instant embodiment as well, frequency components and throughputs of these signals are significantly lower than those of the recording waveform having been subjected to the write strategy process, and thus adverse effects of the recording EFM signal and basic clock pulses WCLK transferred via the flexible substrate 150 can be only nominal.

Further, in the pickup section 200, an OPC sample-and-hold circuit 206 samples and holds predetermined ones of the output current values of the reproducing photodiodes 302a to 302f in synchronism with the corresponding sampling clock pulses, when the OPC control is to be performed. The predetermined ones of the output current values of the reproducing photodiodes 302a to 302f differ with a specific scheme of the OPC control employed. Note that the output current values of the reproducing photodiodes 302a to 302f are supplied via the reproduced light processing circuit 202 in the instant embodiment. Reference numeral 204 represents an ROPC sample-sample-and-hold circuit which samples and holds the output current values of the reproducing photodiodes 302a to 302f in synchronism with the corresponding sampling clock pulses, during the writing process on the optical disk.

The pickup section 200 also includes a current-to-voltage (I/V) conversion circuit 210 that converts the output current of the front monitor diode 301 into a voltage signal corresponding to the output current. Reference numeral 208 represents a sample-and-hold circuit that samples and holds the output current of the front monitor diode 301 and peak and bottom values of the output current of the front monitor diode 301.

Further, in the pickup section 200, an A/D converter (ADC) 226 converts the output voltage of each of the sample-and-hold circuits 204, 206 and 208 into a digital signal. Reference numeral 230 represents a laser DSP that, as necessary, stores into a memory 231 the converted digital values. The laser DSP 230 also calculates target values of the amount of light emission from the laser diode 300 (i.e., output current of the front monitor diode 301) corresponding to various levels of the recording waveform (part (b) in FIG. 3), and outputs designated values of the constant currents IIW, IIE and IIR.

Reference numeral 232 represents a current D/A converter (DAC) that divides the constant current from the current supply/consumption circuit 122, on the basis of the designated values output from the laser DSP 230, to provide the constant currents IIW, IIE, IIR and IIB. The pickup section 200 also includes a laser driver 222 that superposes the constant currents IIW, IIE, IIR and IIB with their respective levels switched in accordance with the control pulses supplied from the write strategy circuit 224 and outputs the superposed result as the laser-diode driving current. Reference numeral 234 represents a noise superposition circuit that imparts noise to the laser-diode driving current output from the laser driver 222.

1.1.2. Construction of Laser Driver 222:

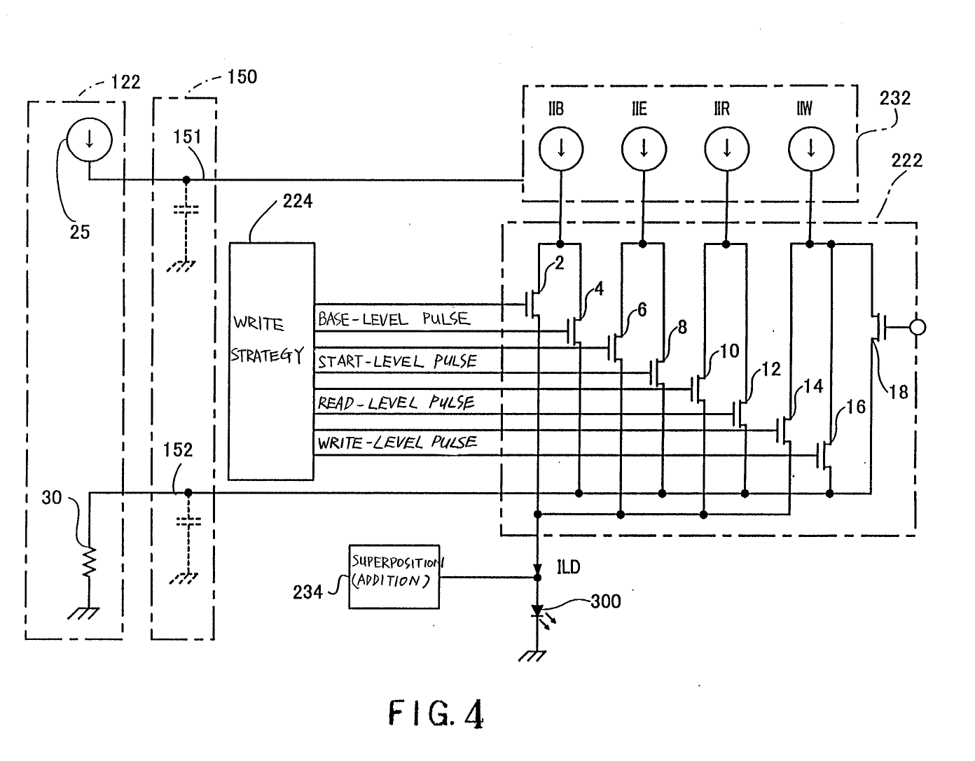

Construction of the laser driver 222 will now be described in detail with reference to FIG. 4. In FIG. 4, reference numerals 2 to 16 are FETs that are paired in corresponding relation to the constant currents IIW, IIE, IIR and IIB. The drains of each of the paired FETs are connected to the corresponding constant-current supply.

In the paired FETs, a base-level pulse, start-level pulse, read-level pulse and write-level pulses are supplied, in positive logic, to the gates of the FETs 2, 6, 10 and 14 (left-side FETs of the individual FET pairs), respectively, while control pulses are supplied, in negative logic, to the gates of the FETs 4, 8, 12 and 16 (right-side FETs of the individual FET pairs).

Thus, ON/OFF states of the paired FETs will be switched in a complementary fashion. The output currents of the FETs 2, 6, 10 and 14 driven in positive logic are superposed so that the superposed result is output as a driving current ILD to the laser diode 300. The output currents of the FETs 4, 8, 12 and 16 driven in negative logic are also superposed.

The driving current ILD is supplied via the flexible substrate 150 to the dummy load 30 within the current supply/consumption circuit 122. The dummy load 30 has an impedance equal to that of the laser diode 300. Note that the FET 18 provided within the laser driver 222 is used only when the APC control is to be performed in an analog manner and is not actually used in the instant embodiment.

In the instant embodiment, the switching of the constant currents IIW, IIE, IIR and IIB is performed within the pickup section 200, so that there is no need to transfer, via the flexible substrate 150, the great laser-diode driving current ILD containing a lot of high-frequency components. Therefore, the laser-diode driving current can be changed in value rapidly. Note that there will be presented no significant inconvenience even if high-frequency components of the current supplied to the dummy load 30 are attenuated in the flexible substrate 150.

Further, in the instant embodiment, the output values of the individual constant currents IIW, IIE, IIR and IIB can be kept constant irrespective of a change in the value of the laser-diode driving current ILD. Thus, it is possible to prevent undesired a ringing effect that would otherwise occur due to rapid ON/OFF of the current. It can also be appreciated that this inventive arrangement allows the current D/A converter 232 to operate in a stable manner and will prove even more useful in high-speed writing on the optical disk.

1.2 Operation of First Embodiment:

The following paragraphs describe operation of the optical disk writing apparatus in accordance with the first embodiment. First, once writing onto the optical disk is instructed by a user or the like, the operation mode of the optical disk writing apparatus is set to the OPC mode. Namely, the microcomputer 120 issues a test writing instruction via the serial interface 118 of the main sheet section 100 such that a predetermined test pattern is written onto an OPC test area with a recording current, recording waveform and the like of the laser diode 300 varied in a stepwise manner. For this purpose, the actuator 170 is controlled via the servo DSP 106 in such a manner that the pickup section 200 is positioned so as to be opposed to the test area of the optical disk.

Then, the test pattern thus recorded on the test area of the optical disk is read out via the reproduced light processing circuit 202, and the read-out result is supplied as a reproduced EFM signal to the main sheet section 100. The microcomputer 120 in the main sheet section 100 compares the test pattern (i.e., instructed contents for the test writing operation) and the reproduced EFM signal and estimates an optimal recording current waveform on the basis of the compared result. The thus-estimated optimal recording current waveform is provided as a target value for the APC control operation.

After completion of the OPC control operation, the target value for the APC control operation is written into the memory 131 on the basis of the results of the OPC control operation. After that, the microcomputer 120 shifts the operation mode into a regular recording mode. Namely, a recording EFM signal is generated by the encoder 116 on the basis of the digital signal supplied from the outside, and the thus-generated recording EFM signal is supplied from the encoder 116 to the pickup section 200. At that time, the write enable signal is set to an ON state.

In the regular recording mode, the APC control operation is carried out by sampling the output current of the front monitor diode while the recording EFM signal is at the value “1”. Further, in a time period when the recording EFM signal is at the value “0”, the recording waveform is set to the read level, as shown in FIG. 3, and the track written previously is read via the reproducing photodiodes 302a to 302d. Thus, actuator control is performed, in which the servo signals to the actuator are sampled on the basis of the result of the track readout.

2. Second Embodiment:

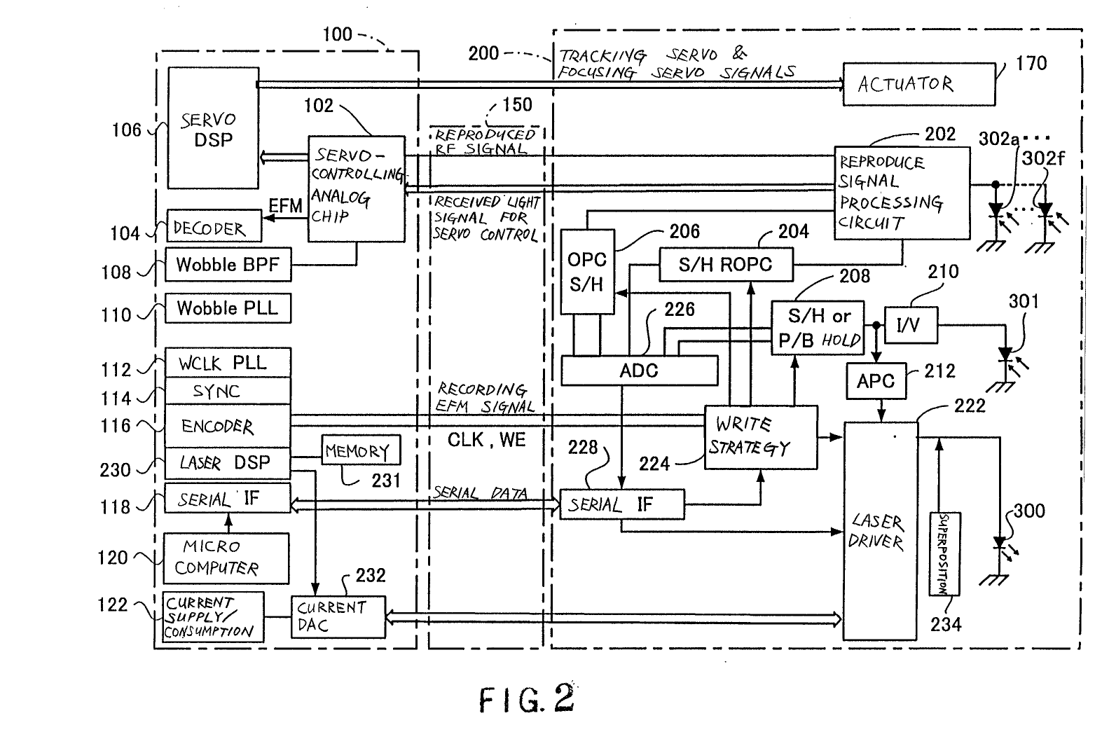

Now, a description will be made about a second embodiment of the present invention with reference to FIG. 2. FIG. 2 is a block diagram showing a general setup of the optical disk writing apparatus in accordance with the second embodiment of the present invention, where elements corresponding in construction and function to those of FIG. 1 are denoted by the same reference numerals and will not be described to avoid unnecessary duplication.

In the second embodiment of FIG. 2, the laser DSP 230, memory 231 and current D/A converter 232 are provided in the main sheet section 100 rather than in the pickup section 200. Thus, the output values of the individual sample-and-hold circuits 204, 206 and 208 are converted into a serial signal via the serial interface 228 and then supplied to the laser DSP 230 via the flexible substrate or signal transmission path section 150 and serial interface 118. Further, the four constant currents IIW, IIE, IIR and IIB generated via the current D/A converter 232 are supplied to the laser driver 222 via the flexible substrate 150.

Namely, because the laser DSP 230, memory 231 and current D/A converter 232 are provided in the main sheet section 100, the second embodiment can even further reduce the amount of heat emitted from the pickup section 200.

Further, in the second embodiment, the target value for the APC control operation is not only used for control of the current D/A converter 232 in the main sheet section 100 but also supplied to the pickup section 200 via the serial interface 118. The pickup section 200 in the second embodiment further includes an analog APC circuit, which comprises a D/A converter for converting the above-mentioned target value into a corresponding voltage level and a differential amplifier that generates a voltage proportional to a difference or offset between the amount of the light emission in form of a voltage level (output voltage of the I/V conversion circuit 210) and the target value.

The output voltage of the differential amplifier in the analog APC circuit of the pickup section 200 is applied to the gate of the FET 18 of the laser driver 222. Thus, if the amount of light emission from the pickup section 200 is too great, the value of the current bypassed via the FET 18 is increased so that the laser-diode driving current ILD is automatically controlled to approach the target value. Namely, the optical disk writing apparatus in accordance with the second embodiment includes, in parallel, (1) a digital APC loop arranged to supply the sampled and held values to the laser DSP 230 via the A/D converter 226, serial interface 228 and serial interface 118 and thereby control the constant currents IIW, IIE, IIR and IIB and (2) an analog APC loop arranged to transmit the target value from the laser DSP 230 to the APC circuit 212 via the serial interface 118 and serial interface 228 and thereby control the value of the current, bypassed via the EFT 18, on the basis of the difference between the target value and the detected light emission amount.

Technical significance of providing two such APC loops is as follows. First, the digital APC loop permits storage of respective initial values of the constant currents IIW, IIE, IIR and IIB in the memory 231. These initial values are values of the constant currents IIW, IIE, IIR and IIB detected when the last writing process was completed. In the additional writing process or the like, environmental conditions, such as ambient temperature, tend to differ between the last and current executions of the process. Thus, the initial values of the constant currents IIW, IIE, IIR and IIB are not always optimal values but can be near the optimal to some extent. The analog APC loop, on the other hand, has to initiate the automatic control with no information related to the initial values. Therefore, the digital APC loop is advantageous over the analog APC loop in that it can set the constant currents IIW, IIE, IIR and IIB to respective initial values somewhat close to the optimal values.

However, because the digital APC loop is arranged to transmit the constant current information via the flexible substrate 150 after converting the parallel signals into the serial signal, the response speed of the digital APC loop would become relatively low so that the digital APC loop can not appropriately meet the demand for high-speed optical disk writing. Thus, the second embodiment is provided with both of the digital and analog APC loops, so as to provide a control device which simultaneously achieves the benefits of the two loops that the constant currents IIW, IIE, IIR and IIB can be set to respective initial values somewhat close to the optimal values and high-speed response can be attained.

3. Modification:

It should be appreciated that the present invention is never limited to the above-described embodiments and various modifications of the present invention are also possible. For example, although the embodiments have been described above as applied to an optical disk writing apparatus, the basic principles of the present invention may also be applied to processing of any other recording media than the optical disks and other electronic equipment than the optical disk writing apparatus.

In summary, the present invention arranged in the above-mentioned manner permits high-speed writing onto optical disks and various other recording media.

What is claimed is:

1. A square-wave modifying device for use in a recording apparatus comprising a pickup section provided in proximity to a recording medium, a flexible signal transmission path section connected to said pickup section and having a character of attenuating a high-frequency component of a signal to be transmitted therethrough and a main sheet section connected to said pickup section via said signal transmission path section, said square-wave modifying device comprising:
a square-wave signal transmission section, provided in said main sheet section, for supplying a first square-wave signal to one end of said signal transmission path section; and
a waveform modification section, provided in said pickup section, for receiving a second square-wave signal from another end of said signal transmission path section, said waveform modification section modifying a waveform of said second square-wave signal so that a level of the waveform is raised for a predetermined first time period at timing near a rise of said second square-wave signal and the level of the waveform is lowered for a predetermined second time period at timing near a fall of said second square-wave signal.

2. A square-wave modifying device for use in a recording apparatus comprising a pickup section provided in proximity to a recording medium, a flexible signal transmission path section connected to said pickup section and having a character of attenuating a high-frequency component of a signal to be transmitted therethrough and a main sheet section connected to said pickup section via said signal transmission path section, said square-wave modifying device comprising:
a square-wave signal transmission section, provided in said main sheet section, for supplying a first square-wave signal to one end of said signal transmission path section; and
a waveform modification section, provided in said pickup section, for receiving a second square-wave signal from another end of said signal transmission path section of said second square-wave wave signal so that the waveform is raised at timing near a rise of said second square-wave signal and upper level of the waveform is raised for a predetermined first time period, and the waveform is lowered at timing near a fall of said second square-wave signal and an under level of the waveform is lowered for a predetermined second time period.

3. A square-wave modifying device for use in a recording apparatus comprising a pickup section provided in proximity to a recording medium, a flexible signal transmission path section connected to said pickup section and having a character of attenuating a high-frequency component of a signal to be transmitted therethrough and a main sheet section connected to said pickup section via said signal transmission path section, said square-wave modifying device comprising:
a square-wave signal transmission section, provided in said main sheet section, for supplying a first square-wave signal to one end of said signal transmission path section; and
a waveform modification section, provided in said pickup section, for receiving a second square-wave signal from another end of said signal transmission path section of said second square-wave signal so that the waveform is raised at timing near a rise of said second square-wave signal and an upper level of the waveform is raised for a predetermined first time period, and the waveform is lowered at timing near a fall of a write-level pulse and an under level of the waveform is lowered for a predetermined second time period.

4. A light emission control device for use in a recording apparatus comprising a pickup section provided in proximity to a recording medium, a flexible signal transmission path section connected to said pickup section and having a character of attenuating a high-frequency component of a signal to be transmitted therethrough and a main sheet section connected to said pickup section via said signal transmission path section, said light emission control device comprising:
a light-emitting element provided in said pickup section;
a first light-receiving element provided in said pickup section;
a second light-receiving element provided in said pickup section;
a storage section, provided in said pickup section, for storing a target value of an amount of light reception by said second light-receiving element;
a control, provided in said pickup section, for, in a first operation mode, adjusting an amount of light emission by said light-emitting element so that the amount of light received by said second light-receiving element approaches the target value, and for, in a second operation mode, writing, into said storage section, another target value obtained on the basis of an amount of light received by said first light-receiving element; and
an operation mode setting section, provided in said main sheet section, for indicating an operation mode to be selected to said control via said signal transmission path section.

5. A light emission control device as claimed in claim 4 wherein said control receives, as a digital signal, the amount of light received by said second light-receiving element and supplies, as a digital signal, the amount of light emission by said light-emitting element, and
which further comprises:
an A/D converter for converting an output current value of said second light-receiving element into a digital signal and supplies the converted digital signal to said control; and
a D/A converter for, on the basis of the amount of light emission represented by the digital signal supplied by said control, outputting a signal proportional to a value of a current to be supplied to said light-emitting element.

6. A light emission control device for use in a recording apparatus comprising a pickup section provided in proximity to a recording medium, a flexible signal transmission path section connected to said pickup section and having a character of attenuating a high-frequency component of a signal to be transmitted therethrough and a main sheet section connected to via said signal transmission path section to said pickup section, said light emission control device comprising:
a light-emitting element provided in said pickup section;
a first light-receiving element provided in said pickup section;
a second light-receiving element provided in said pickup section;
a received-light-amount transmission section, provided in said pickup section, for converting the amount of light received by said second light-receiving element into a first serial signal and transmitting said first serial signal to said main sheet section via said signal transmission path section;
a control information generation section, provided in said main sheet section, for generating control information for controlling an amount of light emission by said light-emitting element on the basis of said amount of light received having been supplied via said signal transmission path section; and
a control information transmission section, provided in said main sheet section, for converting the control information into a second serial signal and transmitting said second serial signal to said pickup section via said signal transmission path section.

7. A control device comprising:
a first feedback loop for detecting an amount of light emission by a light-emitting element and outputting a first operation amount for controlling a predetermined object of control in accordance with a difference between the detected amount of light emission and a target light emission value; and
a second feedback loop for outputting a second operation amount for controlling the predetermined object of control in accordance with a difference between the detected amount of light emission and the target light emission value, said second feedback loop having a lower response speed than said first feedback loop,
wherein the amount of light emission by said light-emitting element is controlled to approach said target light emission value.

8. A control device as claimed in claim 5 wherein said first feedback loop includes a differential amplifier that receives the amount of light emission and the target light emission value as analog signals and outputs said first operation amount as an analog value, and
wherein said second feedback loop includes:
an A/D converter for converting the amount of light emission into a digital value;
a memory for storing the target light emission value as a digital value;
a control that outputs said second operation amount as a digital value on the basis of the digital values representing the amount of light emission and the target light emission value; and
a D/A converter for converting said second operation amount into an analog value.

9. A current supply device for use in a recording apparatus comprising a pickup section provided in proximity to a recording medium, a flexible signal transmission path section connected to said pickup section and having a character of attenuating a high-frequency component of a current to be transmitted therethrough and a main sheet section connected via said signal transmission path section to said pickup section, said current supply device supplying, via a switch section, a current from said main sheet section to a light-emitting element load within said pickup section, said current supply device comprising:
first and second signal lines provided in said signal transmission path section and each having a character of attenuating a high-frequency component of a current to be transmitted therethrough;
a current supply, provided in said main sheet section, for supplying a constant current to said pickup section via said first signal line;
a dummy load provided in said main sheet section;
said switch section, provided in said pickup section, for feeding the current, supplied via said first signal line, to said light-emitting element or to the dummy load via said second signal line while switching between said light-emitting element and said dummy load in a complementary fashion.
